(19) United States
(12) Patent Application Publication
(10) Pub. No.: US 2025/0363900 A1
(43) Pub. Date: Nov. 27, 2025

(54) SYSTEM AND METHOD FOR GENERATING EDUCATIONAL CONTENT BASED ON EDUCATIONAL STANDARDS ENRICHED WITH CONTEXTUAL INFORMATION USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Isaac Squires, Hesperus, CO (US); Simon Said, Malta (MA); Bogdan Tenea, Bucharest (TR); Niraj Patel, London (GB); Janet Demir, Ortaca (TR)

(73) Assignee: 2hr Learning, Inc., Austin, TX (US)

(21) Appl. No.: 19/218,325

(22) Filed: May 25, 2025

Related U.S. Application Data
(60) Provisional application No. 63/652,141, filed on May 27, 2024.

(51) Int. Cl. G09B 5/02; G06N 3/042

(52) U.S. Cl. CPC G09B 5/02; G06N 3/042

(57) ABSTRACT

A method is provided for guiding an Artificial Intelligence (AI) engine to generate enriched educational content by contextualizing educational standards with additional information. The method includes accessing a curriculum database containing educational standards and defining multiple extended attribute types, each representing a category of contextual data relevant to the standards. Detailed extended attributes are associated with these types and linked to specific courses within the curriculum, enabling content generation that aligns with both the standards and their educational context. A prompt is generated to direct a Large Language Model (LLM) to map the extended attributes to the corresponding educational standards. This prompt is transferred to the AI engine, enabling it to recognize and apply the extended attribute types for generating contextually enriched educational content. The approach enhances the instructional depth and relevance of AI-generated materials while maintaining alignment with curriculum guidelines.

### CROSS-REFERENCE TO RELATED APPLICATION

This application claims the benefit under 35 U.S.C. § 119 (e) and 37 C.F.R. § 1.78 of U.S. Provisional Application No. 63/652,141, filed May 27, 2024, which is incorporated by reference in its entirety.

### FIELD OF THE INVENTION

The present invention relates in general to the field of electronics, and more specifically to generate educational content based on educational standards that are enriched with additional contextual information.

### BACKGROUND OF THE INVENTION

In the education sector, content generation is a process of creating, curating, and organizing educational content and resources for teaching and learning purposes using a content generation system. The content generation system ensures that all resources align with curriculum standards and learning objectives while incorporating personalized and adaptive elements to cater to diverse learning styles. Historically, the content generation relied on a direct interpretation of the educational standards without additional contextual or supportive information. The creation of educational material was strictly based on the wording of the educational standards, without much consideration for the diverse needs of learners. As a result, there was a significant gap in the ability to systematically link educational standards to enriched content that could cater to various learning styles and preferences. The lack of contextualization often led to educational content that was too rigid and narrowly focused, missing out on opportunities to enhance understanding through additional examples, explanations, and engaging content.

While some efforts may have been made to contextualize content to specific courses or educational standards, these were not as structured or comprehensive. Attempts to make educational content more relevant often lacked a systematic approach, resulting in inconsistent quality and coverage. Without a robust framework to guide the enrichment of content, these efforts were typically fragmented and varied widely in their effectiveness. Consequently, the educational content produced was often insufficient to fully address the complexities and nuances of the educational standards, leaving gaps in students' knowledge and understanding.

Conventional content generation system has been limited by the scope of the educational standards, often resulting in materials that lack depth and fail to address all aspects of the educational standard. The conventional content generation often faced challenges due to the broad nature of curriculum standards, which resulted in content that was not sufficiently detailed or engaging. Conventional methods typically did not account for the nuances of each standard, leading to a lack of granularity and missing key concepts that are crucial for a deeper understanding of the subject matter. This often resulted in educational materials that were repetitive and failed to capture the attention of students, thereby limiting engagement and potentially hindering learning outcomes.

The conventional content generation may not have systematically linked additional information to both educational standards and courses, potentially leading to less targeted and effective educational content. The disconnect between the standards and the enriched content meant that educational resources were often generic and not tailored to the specific needs of different educational contexts. This lack of targeted content made it difficult to meet the diverse needs of students, as the content was not specifically designed to address varying learning styles, backgrounds, and levels of understanding. Consequently, students may have found the materials less relevant and engaging, impacting their motivation and overall learning experience.

Conventional content generation systems may not have the capability to dynamically create such diverse and engaging content that is also aligned with educational standards. The static nature of the conventional content generation system meant that content could not easily be adapted or updated to reflect changes in standards or the latest educational best practices. This prevents educators from providing the most current and effective resources to the students. Moreover, the inability to dynamically generate content limits the potential for personalization and differentiation, which are crucial for addressing the individual needs of learners and fostering a more inclusive and effective educational environment.

### SUMMARY

A method for guiding an artificial intelligence (AI) engine to generate educational content by enriching educational standards with additional contextual information includes executing code using one or more processors of a computer system to cause the computer system to perform operations. The method includes accessing a curriculum database comprising curriculum guidelines associated with educational standards. The method also includes defining a plurality of extended attribute types, wherein each extended attribute type represents a specific category of supplementary information relevant to the educational standards. The method further includes associating the extended attribute types with corresponding extended attributes, wherein the extended attributes provide detailed information under each attribute type.

The method includes linking the extended attributes to specific courses within the educational standards to ensure that generated educational content is contextually aligned with curriculum requirements. The method also includes generating a prompt to guide the AI engine, wherein the prompt is configured to guide a Large Language Model (LLM) to recognize and map the extended attributes to corresponding educational standards. The method further includes transferring the prompt to the AI engine to facilitate content generation that is both contextually enriched and standards-aligned.

A system for guiding an artificial intelligence (AI) engine to generate educational content by enriching educational standards with additional contextual information includes one or more processors and a memory coupled to the one or more processors, the memory storing code that when executed causes the computer system to perform operations. The system includes accessing a curriculum database comprising curriculum guidelines for educational standards. The system also includes defining a plurality of extended attribute types, wherein each extended attribute type represents a specific category of supplementary information. The system includes associating the extended attribute types with extended attributes containing detailed contextual information.

The system includes linking the extended attributes to specific courses of the educational standards, thereby contextualizing educational content to align with the curriculum. The system further includes generating a prompt configured to guide a Large Language Model (LLM) to map the extended attributes to the educational standards. The system includes transferring the prompt to the AI engine to enable the recognition and mapping of the extended attribute types to generate content that is enriched and consistent with the educational standards.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary content generation system for generating educational content by enriching educational standards with additional contextual information.

FIG. 2 depicts an exemplary content generation process utilized by the exemplary content generation system of FIG. 1.

FIG. 3 is a mapping process for mapping the extended attributes to specific educational standards, which is an embodiment of the content generation process of FIG. 2.

FIG. 4 depicts an exemplary sequence diagram for generating content.

FIG. 5 depicts an exemplary sequence diagram for generating lesson plans.

FIG. 6 depicts an exemplary sequence diagram for generating personalized content.

FIG. 7 depicts a data structure depicting relationships between the plurality of extended attribute types with the educational standards and courses.

FIG. 8 depicts an exemplary network environment in which the system of FIG. 1 and the process of FIG. 2 may be practiced.

FIG. 9 depicts an exemplary computer system.

### DETAILED DESCRIPTION

A content generation system provides a structured way to enrich educational standards with additional, detailed information through extended attribute types to provide a nuanced understanding of each educational standard, facilitating the creation of educational content that is granular, comprehensive, and tailored to the needs of the user. The content generation system is configured to mapping extended attributes to specific educational standards. Moreover, an AI engine is guided to recognize and align the extended attributes for enhancing educational content. Typically mapping involves linking extended attributes to courses within educational standards to ensure that supplementary information such as instructional strategies, assessment methods, and learning resources are systematically aligned with the educational standards. Moreover, a prompt is generated for guiding the AI engine, that guides a Large Language Model (LLM), to map extended attributes to educational standards.

Moreover, the content generation system comprises a set of extended attribute types, such as clarification statements, assessment boundaries, learning objectives, key terms, skills, and historical figures. Each extended attribute is a specific instance that carries a value and may belong to a category within the extended attribute type. For example, attribute types have the value “photosynthesis” and belong to the category of “Biology”. The content generation system systematically links extended attributes to specific educational standards and courses, ensuring that the generated content is not only standard-aligned but also contextually relevant to the course. Typically, the mapping associates extended attributes with both education standards and courses allowing for precise tailoring of content to meet the educational requirements of different learning environments. The content generation system accesses a curriculum database that includes guidelines for educational standards.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

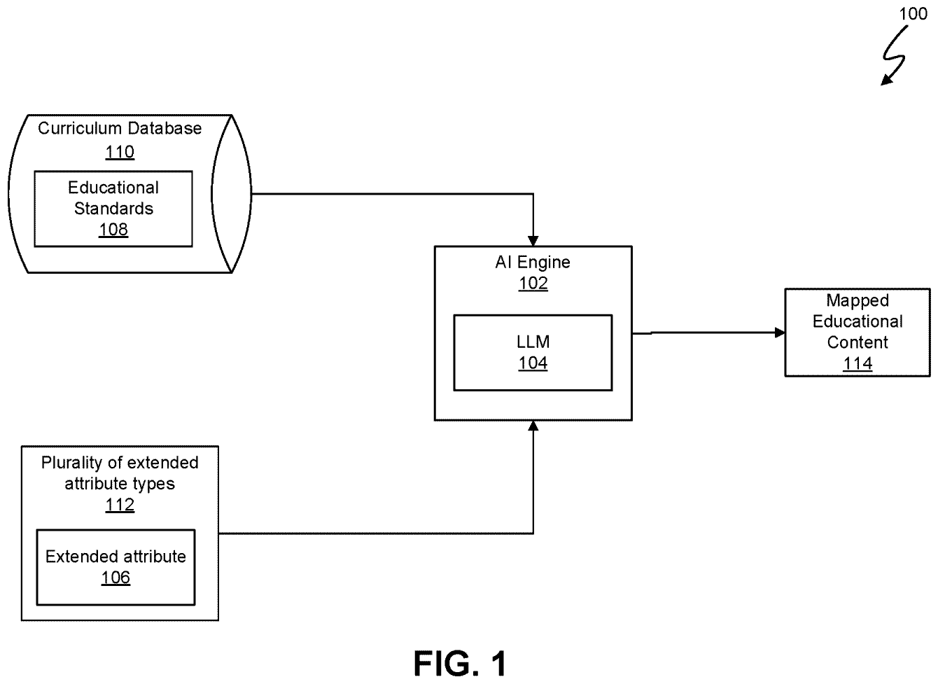

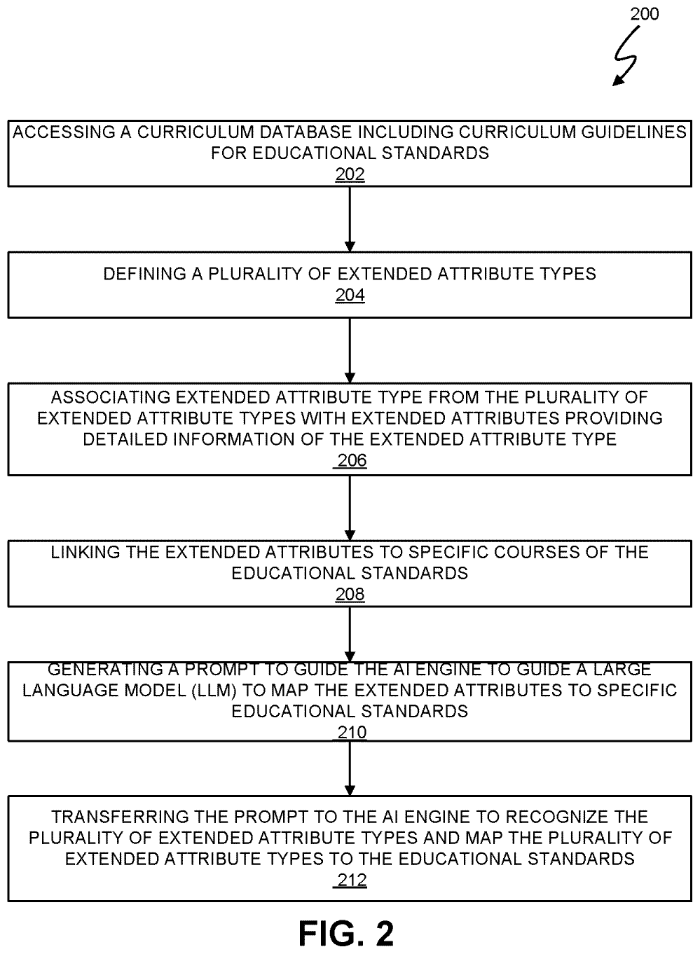

FIG. 1 depicts an exemplary content generation system 100 for generating educational content by enriching educational standards with additional contextual information. FIG. 2 depicts an exemplary content generation process 200 utilized by the content generation system 100.

The Artificial Intelligence (AI) engine 102 is designed to guide a Large Language Model (LLM) 104 to map the extended attributes 106 to specific educational standards 108. The AI engine 102 is configured to generate educational content that is both aligned with educational standards 108 and tailored to the specific needs of a user. Typically, the extended attributes 106 provide a structured way to enrich educational standards 108 with additional information allowing nuanced understanding of each educational standard 108.

Referring to FIG. 1 and FIG. 2, in operation 202, accessing a curriculum database 110 including curriculum guidelines for educational standards 108. The curriculum database 110 is a digital repository that is configured to store curriculum guidelines, educational contents, lesson plans, instructional resources, and assessment tools. The curriculum database 110 serves as centralized platforms to retrieve and utilize educational materials tailored to specific educational standards 108. The curriculum guidelines embedded in the curriculum database 110 are aligned with national or regional educational standards 108. The educational standards 108, set by educational authorities, outline the learning objectives and competencies the user is expected to achieve at various stages of their education journey. The curriculum guidelines ensure that teaching practices and lesson plans meet the prescribed educational outcomes. The curriculum database 110 provides direct links to the educational standards 108, allowing to cross-reference the lesson plans with the expected competencies and outcomes.

In addition to curriculum guidelines, the curriculum database 110 houses a variety of instructional resources such as lesson plans, study materials, worksheets, and assessment tools provided to the user during a specific grade. The resources are curated and regularly updated to reflect the latest educational research and pedagogical practices. The curriculum database 110 includes curriculum data aligned to one or more educational standards including Common Core State Standards (CCSS), Next Generation Science Standards (NGSS), and Advanced Placement (AP).

In operation 204, defining a plurality of extended attribute types 112. Typically, each extended attribute type represents a specific category of additional information relevant to the educational standard 108. The plurality of extended attribute types 112 provide context, additional insights that help in the effective implementation and assessment of educational standards 108. The plurality of extended attribute types 112 identifies the key areas where additional information corresponding to the educational standard 108 is utilized to categorize the extended attribute type in a systematic and accessible manner. The comprehensive analysis of the educational standards is conducted to define plurality of extended attribute types 112. Typically, to define the plurality of extended attribute types 112, the understanding of the objectives, competencies, and outcomes of the educational standards 108 is analyzed. This may be achieved by dissecting the educational standards 108 to identify gaps where additional information is needed. For example, an exemplary educational standard may specify that the user should develop critical thinking skills in mathematics, but it may not provide details on specific pedagogical approaches that can best foster the skills. The extended attribute type includes recommended teaching methodologies, such as problem-based learning or inquiry-based instruction, tailored to enhance critical thinking in mathematical contexts.

Each extended attribute type from the plurality extended attribute type 112 represents a specific category of information that is relevant to educational standards 108. The category of additional information includes instructional strategies, assessment tools, learning resources, technological aids, differentiation techniques, and socio-emotional learning supports. The process of defining and categorizing the plurality of extended attribute types 112 ensures that each extended attribute type is comprehensive, relevant, and practical. Furthermore, the use of educational standards 108 helps in identifying trends, gaps, and areas of need requiring development of the plurality of extended attribute types 112 and allows access and integration with the educational standards 108.

In operation 206, associating extended attribute type from the plurality of extended attribute types 112 with extended attributes 106 providing detailed information of the extended attribute type. Typically, the extended attribute types are categories of information that add depth to educational standards 108. Each extended attribute type represents a broad area of educational enhancement that supports and enriches the educational standards 108. The association of the extended attribute types with extended attributes 106 involves linking each extended attribute type to specific educational standards 108. Typically, the extended attribute provides detailed information to elaborate on the extended attribute types by identifying and defining the extended attribute types. Once the extended attribute types are defined, then each extended attribute type is populated with detailed extended attributes 106. The extended attributes 106 are the specific pieces of information or resources that fall under each extended attribute type.

Moreover, associating extended attribute types with extended attributes 106 is done to ensure alignment with the educational standards 108. Notably, each extended attribute is linked to the educational standard 108. For example, if the educational standard 108 specifies that the user should develop critical thinking skills in science, the extended attributes 106 associated with the instructional strategies type should include methods and examples that specifically promote critical thinking in scientific contexts.

In operation 208, linking the extended attributes 106 to specific courses of the educational standards 108, ensuring that the educational content generated is contextualized to the curriculum guidelines for the educational standards 108. Typically, the educational standards 108 outline the knowledge, skills, and competencies that the user is expected to acquire at various stages of their education journey. The educational content is designed such that to meet the educational standards 108, providing structured and systematic instruction to contextualize the curriculum guidelines for the educational standards 108. Typically, linking extended attributes 106 to the specific educational courses requires a detailed mapping of the educational standards 108 to the educational course content, ensuring that every topic of the educational course aligns with the intended educational outcomes. The extended attributes 106 are categories of additional information that enhance the core educational content. The extended attributes 106 can include instructional strategies, assessment methods, learning resources, technological tools, differentiation techniques, and socio-emotional learning supports. Each of the extended attributes 106 provides depth and context.

In particular, the educational standards 108 are reviewed to identify objectives and outcomes for each educational course. For example, science courses for eighth grade have educational standards 108 related to understanding scientific principles, conducting experiments, and applying scientific knowledge to real-world problems. Each of the educational standards 108 needs to be carefully examined to determine where the extended attributes 106 can provide additional support and enhancement. Once the educational course and the corresponding educational standards are identified, the next step is to map the extended attributes 106 to the educational course by linking each extended attribute to the specific educational standards 108 and objectives of the educational course. For example, if an educational course on environmental science has educational standards 108 related to developing critical thinking skills, extended attributes 106 under the instructional strategies category include problem-based learning, inquiry-based instruction, and case studies.

To ensure that the educational content generated is contextualized to the curriculum guidelines a detailed documentation and examples for each extended attribute is provided. The detailed documentation and examples include theoretical explanations, practical implementation steps, and contextualized examples that show how the extended attribute can be applied within the specific educational course. For example, if instruction is an extended attribute linked to an English literature course, the documentation includes strategies for tailoring reading assignments to different reading levels, providing alternative assessments, and using literature circles to promote inclusive discussions. In at least one embodiment, the machine learning algorithms are utilized to suggest relevant extended attributes 106 based on the courses and educational standards allowing personalized approach to ensure that the user receives the pertinent information efficiently, enhancing the relevance and applicability of the extended attributes 106. Moreover, linking the extended attributes 106 to specific courses also involves ensuring that the educational content is relevant and inclusive. For example, when linking instructional strategies to a history course, it is important to include perspectives and resources that cover a wide range of cultures and viewpoints to enrich the educational content and also promote an inclusive and equitable learning environment.

Moreover, using mapping tables that relate educational standards 108 and courses to extended attributes 106 to aligning content generation with established educational standards 108. The mapping tables serve as a structured framework, linking specific educational standards 108 and courses to relevant extended attributes 106 such as instructional strategies, assessment methods, and learning resources. The alignment ensures that the educational content is not only comprehensive and detailed but also tailored to meet the specific objectives of each education standard 108 and course. By contextualizing the content to the respective course, the mapping tables facilitate targeted and effective educational experience. Each extended attribute 106 is a specific instance that carries a distinct value and belongs to a category within the extended attribute type. The categorization allows structured enrichment of educational standards 108 by providing additional, detailed information, ensuring that each standard is supported by relevant and targeted resources.

Identifying the learning style and performance data of the user to personalize educational content by gathering comprehensive information about the user, such as learning preference, learning style. Additionally, performance data is collected to understand the user's current proficiency levels, strengths, and areas needing improvement. Selecting extended attributes 106 based on the identified learning style and performance data involves matching the personalized insights with specific educational standards 108. Generating educational content incorporating the selected extended attributes 106 entails creating or modifying lesson plans and to address the individual learning styles and performance levels, ensuring that the educational content is both relevant and accessible to the user. Moreover, storing performance data of the user, educational content generated in a database.

In operation 210, generating a prompt to guide the AI engine 102 to guide a Large Language Model (LLM) 104 to map the extended attributes 106 to specific educational standards 108, ensuring the contextual enrichment is aligned with the educational standards. The prompt instructs the LLM 104 to produce educational content that is both aligned with educational standards 108 and contextually enriched. The prompt defines the scope and purpose to ensure that the educational content aligns with the educational standards 108, defining the educational skills users are expected to achieve at various educational levels. The prompt is configured to map the extended attributes 106 to the educational standards 108, thereby enriching the educational content with valuable, contextual information. The AI engine 102 is configured to outline the specific educational standards 108 such as identifying the grade level, subject area, and particular educational standards 108 within that subject. For example, the prompt specify, map extended attributes 106 to the educational standards 108 for Grade 10 Biology, focusing on the standards related to genetics, cell biology, and ecosystems. By defining the scope, the prompt ensures that the AI engine 102 concentrates on the relevant educational standards 108 and avoids generating extraneous content.

The prompt identifies the types of extended attributes 106 to be mapped. The prompt provides detailed descriptions of the extended attributes 106, guiding the AI engine 102 to map the extended attributes 106 to specific educational standards. The AI engine 102 instructs the LLM 104 to ensure that the extended attributes 106 are tailored to the educational standards 108. For example, for the educational standard 108 related to understanding genetic inheritance, provide an inquiry-based learning activity where the user analyzes family genetic data to identify inheritance patterns. The prompt to guide the AI engine 102 to customize the extended attributes 106 to address different learning styles, abilities, and backgrounds.

Training the AI engine 102 on a dataset comprising educational standards 108, extended attributes 106, and user performance data for developing personalized educational content. This training process involves utilizing supervised learning algorithms, which analyze the dataset to predict the most effective content types for individual users. The dataset includes a comprehensive array of educational standards 108, outlining the knowledge and skills users are expected to attain, along with extended attributes 106 such as instructional strategies, assessment methods, and learning resources. Additionally, user performance data provides insights into each strengths, weaknesses, and preferred learning styles of the user, enabling the AI engine 12 to tailor its predictions accordingly. Through supervised learning algorithms, the AI engine 102 learns to recognize patterns and correlations within the dataset, identifying which combinations of educational standards 108 and extended attributes 106 enhance learning outcomes for specific users. By training on the dataset, the AI engine 102 forms informed predictions about the most effective content types for individual users.

In operation 212, transferring the prompt to the AI engine 102 to recognize the plurality of extended attribute types 112 and map the plurality of extended attribute types 112 to the educational standards 108 to generate mapped educational content 114. Typically, the prompt identifies the educational standards 108, ensuring that the AI engine 102 is directed to the correct set of educational standards 108. For example, the prompt specifies to map the extended attribute types to the Common Core State Standards for Mathematics for grades 9-12. Based on the identified educational standards 108 and the extended attribute types, the prompt provides detailed instructions to map the extended attribute types 112 to the educational standards 108. IN this regard, guiding the AI engine 102 to align each type of extended attribute with the relevant educational standards 108. The prompt guides the AI engine 102 to identify the context of the educational standards 108 such as the subject area, grade level, and user demographics to generate mapped education content 114. The AI engine 102 utilizes the LLM 104 for processing vast amounts of data and generating detailed mappings.

Below is the pseudo code for generating enriched education content 114 by iterating over extended attributes of related standards:

```
  # Define a class for ExtendedAttributeTypes
    class ExtendedAttributeTypes:
    def _{——}init_{——}(self, name, description):
    self.name = name
    self.description = description
    # Define a class for ExtendedAttributes
    class ExtendedAttributes:
      def _{——}init_{——}(self, attribute_type, value, category=None):
      self.attribute_type = attribute_type
      self.value = value
      self.category = category
    # Define a class for Standards
    class Standards:
      def _{——}init_{——}(self, standard_id, description):
      self.standard_id = standard_id
      self.description = description
      self.attribute_mappings = [ ]
      # Function to add attribute mappings to a standard
      def add_attribute_mapping(self, extended_attribute):
      self.attribute_mappings.append(extended_attribute)
    # Define a class for Courses
    class Courses:
      def _{——}init_{——}(self, course_id, name):
      self.course_id = course_id
      self.name = name
      self.attribute_mappings = [ ]
      # Function to add attribute mappings to a course
      def add_attribute_mapping(self, extended_attribute):
      self.attribute_mappings.append(extended_attribute)
    # Define a function to create content based on the enriched data
model
    def generate_content(standard):
      content = “”
      # Iterate over each attribute mapping and enrich the
content
      for attribute in standard.attribute_mappings:
      content += f“{attribute.attribute_type.name}:
{attribute.value}\n”
      return content
    # Example usage of the classes and functions
    # Create instances of ExtendedAttributeTypes
    clarification = ExtendedAttributeTypes(“Clarification
Statement”, “Provides additional context”)
    assessment_boundary = ExtendedAttributeTypes(“Assessment
Boundary”, “Defines the scope of assessment”)
    # Create instances of ExtendedAttributes
    clarification_attr = ExtendedAttributes(clarification, “Clarify
the concept of photosynthesis”)
    assessment_boundary_attr =
ExtendedAttributes(assessment_boundary, “Include cellular respiration”)
    # Create a standard and add attribute mappings
    standard = Standards(“SC.4.2.1”, “Understand the process of
photosynthesis”)
    standard.add_attribute_mapping(clarification_attr)
    standard.add_attribute_mapping(assessment_boundary_attr)
    # Generate content for the standard
    content = generate_content(standard)
    print(content)
    # Comments explaining the algorithms:
    # The classes ExtendedAttributeTypes and ExtendedAttributes are
used to define the types of attributes and their specific instances.
    # The Standards and Courses classes contain methods to add
attribute mappings, linking extended attributes to standards and
courses.
    # The generate_content function takes a standard as input and
iterates over its attribute mappings to create enriched educational
content.
```

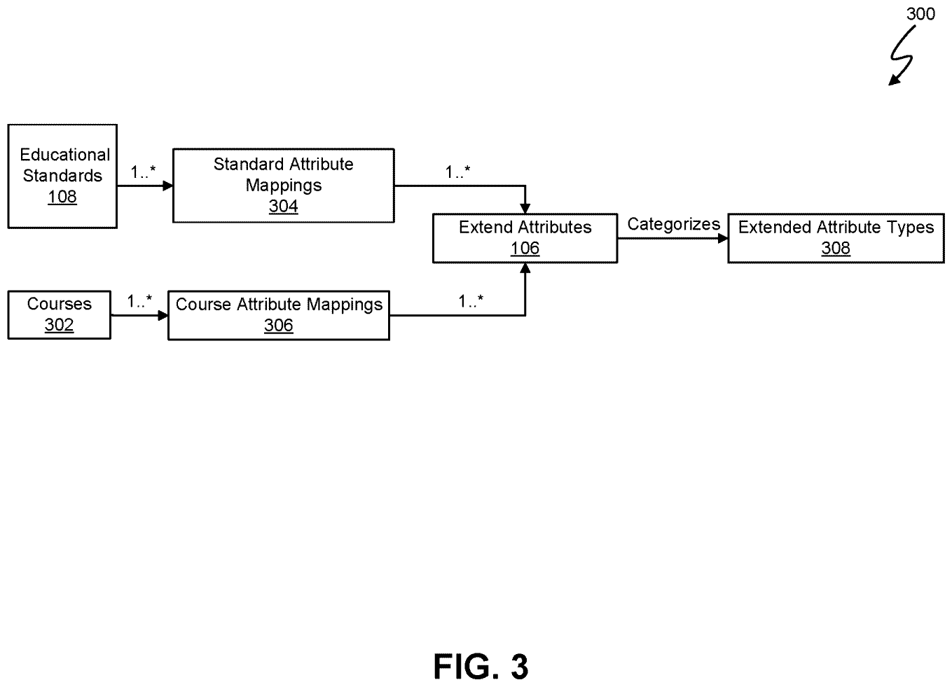

FIG. 3 is a mapping process 300 for mapping the extended attributes 106 to specific educational standards 108, which is an embodiment of the content generation process 200 of FIG. 2. As shown, educational standard 108 and course 302 is identified. A standard education mapping 304 is configured to align educational content with the educational standards 108. The standard education mapping 304 associates each attribute with the relevant education standard 108 to ensure that the content is contextually appropriate and enhances the learning objectives. The standard education mapping 304 ensures that instructional methods, assessment tools, learning aids, and other educational supports are directly linked to facilitate a coherent and targeted educational framework. A course attribute mappings 306 is configured to align various educational resources, strategies, and supports with specific courses 302. The course attribute mappings 306 ensures that educational resources are tied with content of the course 302. The standard education mapping 304 and course attribute mappings 306 is provided to the extended attribute 106. The extended attribute 106 ensures that course 302 is more comprehensive, engaging, and aligned with educational standards 108, thereby improving learning processes.

The extended attribute 106 categorizes the course 302 and educational standards 108 into specific categories such as instructional strategies, assessment methods, learning resources, technological tools, differentiation techniques, and socio-emotional learning supports. Each category provides targeted support to educational standards 108 and content. The extended attribute 106 categorizes and defines extended attribute types 308 by organizing extended attribute 106 into categories, each representing a specific type of additional information that supports and enhances the curriculum.

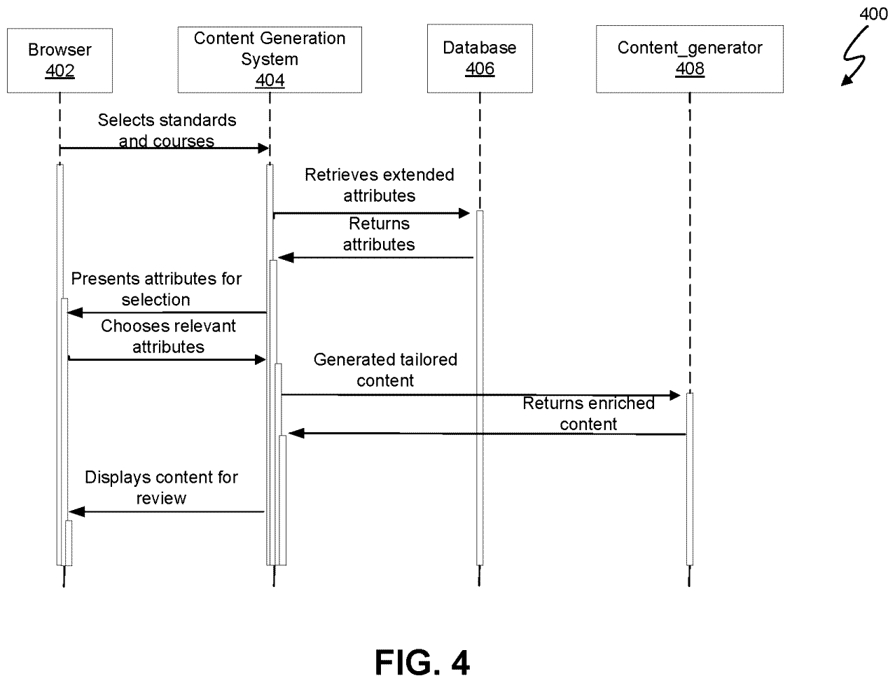

FIG. 4 depicts an exemplary sequence diagram 400 for generating content. As shown, a user on a browser 402 selects educational standard 108 and course 302. A content generation system 404 receives the user request for including selected educational standards 108 and courses 302 and delivers to a database 406. The database 406 is a structured collection of data related to educational standards 108 and courses 302. The database 406 contains information such as extended attribute types and attributes that enrich educational standards 108, course-attribute mappings, and other relevant data. The database 406 serves as a comprehensive and organized repository of information that supports the generation of educational content aligned with curriculum standards and tailored to specific courses. The content generation system 404 retrieves the extended attributes from the database 406 and the database 406 is configured to respond to the requested extended attributes. The retrieved extended attributes are presented to the user on the browser 402 for selection. The user chooses from the extended attributes. Based on the chosen extended attributes content generation system 404 requests content generator 408 to generate the tailored content. The content generator 408 returns the enriched content to the content generation system 404. The content generation system 404 displays the enriched content to the user on the browser 402.

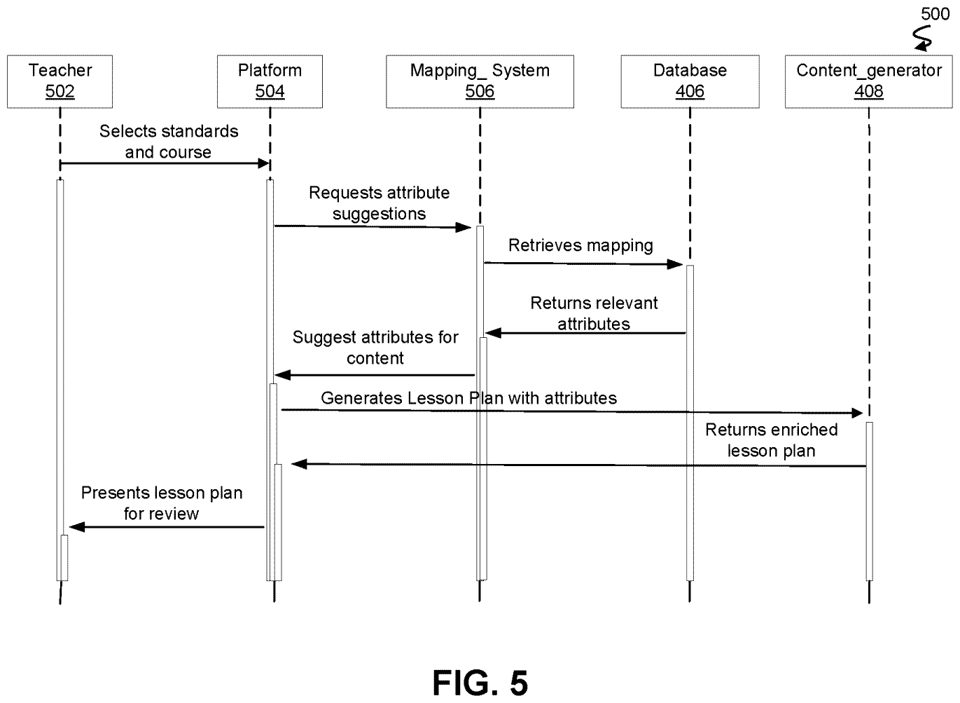

FIG. 5 depicts an exemplary sequence diagram 500 for generating lesson plans. As shown, a teacher 502 selects educational standard 108 and course 302 on a platform 504. The platform requests attribute suggestions on a mapping system 506. The mapping system 506 is a system used to associate the extended attributes 106 to both educational standards 108 and courses 302, ensuring that the content generated is aligned with specific educational standards 108. The mapping system 506 retrieves mapping from the database 406 and the database 406 returns the requested extended attributes to the mapping system 506. The mapping system 506 suggests the extended attributes on the platform 504. The platform 504 directs the content generator 408 to generate a lesson plan based on the extended attributes and the content generator 408 returns the enriched lesson plan to the platform 504. The platform 504 is configured to present the enriched lesson plan to the teacher 502 for review.

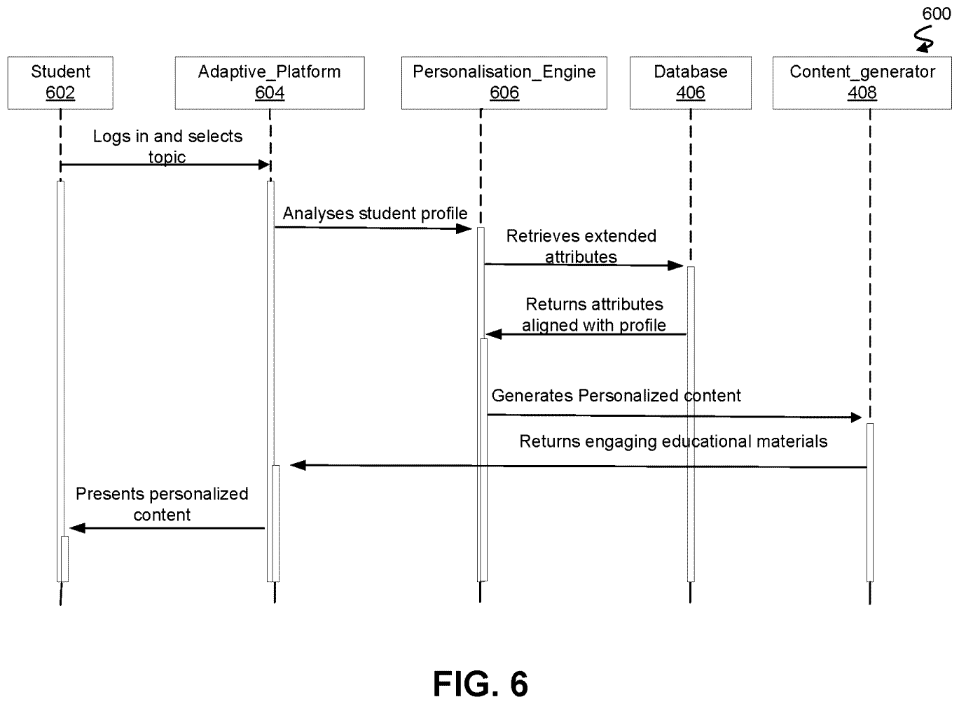

FIG. 6 depicts an exemplary sequence diagram 600 for generating personalized content. As shown, a student 602 logs and selects a topic on an adaptive platform 604. The adaptive platform 604 is a type of educational platform that personalizes the content and provides to the student 602. In at least one embodiment, the adaptive platform 604 can adjust the difficulty level of questions, provide additional support in challenging areas, and offer targeted resources based on the student's performance and learning style. Moreover, the adaptive platform 604 analyzes the student profile and provides a personalization engine 606. The database 406 retrieves extended attributes from the personalization engine 606 and returns the extended attributes aligned to the profile of the student 602 to the personalization engine 606. Furthermore, the personalization engine 606 requests the content generator 408 to generate personalized content based on the aligned extended attributes. The content generator 408 returns the engaging educational material on to the adaptive platform 604. The adaptive platform 604 presents the personalized content to the student 602.

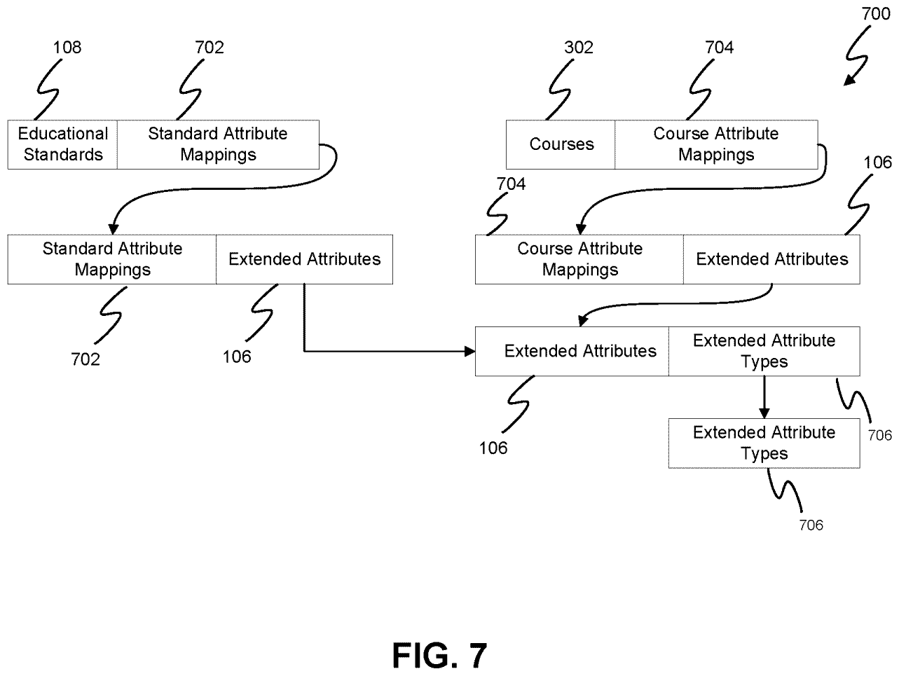

FIG. 7 depicts a data structure 700 depicting relationships between the plurality of extended attribute types 112 with the educational standards 108 and courses 302. As shown, education standards 108 includes standard attribute mappings 702. Typically, the education standards 108 have multiple attributes associated therewith, which are mapped through the standard attribute mappings 702. The standard attribute mappings 702 is connected to the extended attributes 106. Notably, each standard attribute mappings 702 is associated with specific extended attributes 106. Moreover, courses 302 includes course attribute mappings 704. Typically, the courses 302 have multiple attributes associated therewith, which are mapped through the course attribute mappings 704. The course attribute mappings 704 is also connected to the extended attributes 106. The extended attributes 106 is connected to the extended attribute types 706 indicating that the extended attribute types 706 contains definitions and properties of different extended attributes 106, ensuring that extended attributes 106 have a well-defined structure and type.

Provided below are the prompts shared with the AI engine 102 for mapping the extended attributes 106 to specific educational standards 108 and to provide personalized content to the user base don their mastery level on various standards. The output generated by the AI engine 102 may also be validated using validator prompts to ensure that the content provided to the user is as per their mastery level on specific educational standards 108:

Assessment Boundary Prompt: The Assessment Boundary prompt establishes the official scope guardrails for content development. The prompt explicitly lists exclusions, such as advanced notations or out-of-grade content that would inflate cognitive load. The purpose of Assessment Boundary prompt is twofold: a) to keep assessments aligned with grade-level expectations and b) to protect test validity by eliminating unintended sources of difficulty or distraction.

Exemplary Assessment Boundary Prompt is given below—
CONTEXT
   You are an expert curriculum and assessment designer specializing in elementary education and deeply familiar with Common Core State Standards and best practices for assessment alignment.
TASK
   For the substandard, [substandard ID] [substandard description], as defined in Common Core Standard [common core parent standard code], identify the official assessment boundaries for this concept.
INSTRUCTIONS
   Explicitly list what is excluded from assessment for this substandard.
   Boundaries should include:
      Advanced notations, representations, or procedures not required by the standard or grade level.
      Out-of-grade-level content or skills.
      Extraneous cognitive load, such as unfamiliar contexts, complex language, or multi-step reasoning not aligned to the standard's intent.
   For each exclusion, briefly justify why it is outside the assessment boundary (e.g., “not grade-appropriate,” “not required for conceptual understanding,” “would introduce construct-irrelevant difficulty”).
   Ensure boundaries are specific, actionable, and help item writers avoid misalignment with the standard.
   Include at least three assessment boundaries.
   Use clear, concise language appropriate for assessment developers.
OUTPUT
   Return your answer as a JSON array of objects, using the following schema:

```
[
  {
  “excluded”: “string (feature, skill, content, or context to be excluded)”,
    “justification”: “string (brief explanation of why it is excluded from assessment)”
  }
]
      • EXAMPLES
[
  {
    “excluded”: “Mixed numbers and improper fractions”,
    “justification”: “These representations are introduced in later grades and are not required by
this substandard.”
  },
{
“excluded”: Division word problems requiring interpretation of remainders (e.g., rounding up,
down, or expressing as fractions)”,
“Justification”: “Interpreting remainders is a higher-level skill addressed in later standards. For
this substandard, students are only expected to solve problems where the division is exact.”
},
{
“excluded”: “Division problems that result in a remainder”,
“justification”: “This substandard focuses on students' ability to find whole-number quotients
without remainders. Including problems with remainders would introduce concepts not required
at this grade level and could confuse students who are not yet expected to interpret or represent
remainders.”
}
]
```

### Assessment Boundary Validator:

ROLE

You are an expert educational reviewer.
TASK

Your task is to validate the following JSON array of assessment boundaries, which was generated for a specific Common Core substandard.
VALIDATION CRITERIA
   The output must be valid JSON and an array with at least three objects.
   Each object must have both required fields: “excluded” and “justification”.
   All fields must be non-empty, specific, and written in clear, professional language suitable for assessment developers.
   Each “excluded” entry must:
   Clearly identify a feature, skill, content, or context that is not to be assessed for this substandard.
   Be tightly aligned to the substandard's scope and grade level.
   Avoid trivial, overly broad, or vague exclusions.
   Each “justification” must:
   Provide a brief, actionable, and standards-aligned reason for the exclusion (e.g., “not grade-appropriate,” “not required for conceptual understanding,” “would introduce construct-irrelevant difficulty”).
   Not simply restate the exclusion or use circular reasoning.
   Reject outputs that have:
   Vague, generic, or repetitive boundaries.
   Superficial or circular justifications.
   Exclusions that do not fit the concept or grade level.
   Any missing, empty, or placeholder fields.
INSTRUCTIONS
   Carefully review the JSON against all criteria above.
   If the output meets all criteria, respond:
   “VALID: High-quality assessment boundaries output.”
   If any issue is found, respond:
   “INVALID: [brief explanation of what is missing, incorrect, or low-quality].”
   Provide a numbered list of specific issues if any are found.
EXAMPLE OF A HIGH-QUALITY ENTRY

{
“excluded”: “Division problems that result in a remainder”.
“justification”: “This substandard focuses on students' ability to find whole-number
quotients without remainders. Including problems with remainders would introduce
concepts not required at this grade level and could confuse students who are not yet
expected to interpret or represent remainders.”
}

BEGIN VALIDATION NOW.
   Common Misconceptions Prompt: The Common Misconceptions prompt is an inventory of the most typical errors, misunderstandings, or over-generalizations students exhibit when learning the concept. The collection serves two critical purposes: (1) it drives the design of plausible distractors in multiple-choice questions, and (2) it flags high-leverage conceptual gaps that should be surfaced, confronted, and repaired during instruction.

### Exemplary Common Misconceptions Prompt is Given Below—

CONTEXT:
   You are an expert curriculum designer specializing in elementary education and familiar with Common Core State Standards.
TASK:
   For the substandard, [substandard ID] [substandard description], as defined in Common Core Standard [common core parent standard code], and given the following assessment boundary: [assessment boundary], identify the most common and impactful mistakes/misconceptions students exhibit when learning this concept. Only include misconceptions that are within the scope of the assessment boundary.
INSTRUCTIONS:
For each misconception:
   Clearly describe the misconception, ensuring it is specific to the concept and grade-level expectations.
   Ensure the misconception is within the official assessment boundaries for this substandard. Do not include misconceptions about skills, representations, or contexts that are explicitly excluded from assessment (e.g., advanced procedures, out-of-grade content, or extraneous contexts as defined by the assessment boundary).
   Explain why this misconception commonly arises (e.g., prior knowledge, misleading language, everyday experience, or instructional gaps).
   Provide an example of how the misconception might appear in student reasoning, language, or typical errors (include a sample student response or error if helpful).
   Suggest one research-backed instructional strategy or classroom intervention to address and correct this misconception.
      Return your answer as a JSON array of objects, using the following schema:

```
[
  {
    “misconception”: “string (concise description of the misconception)”,
    “why_it_occurs”: “string (explanation of the misconception's origin)”,
    “student_example”: “string (example of student reasoning or error)”,
    “instructional_remedy”: “string (recommended strategy to address it)”
  }
]
```

Include at least two misconceptions, but at most four.

Ensure your list is comprehensive, grounded in classroom and assessment experience, and suitable for designing plausible distractors in multiple-choice questions. Use clear, concise language appropriate for assessment developers.

### EXAMPLES

```
  {
    “misconception”: “A larger denominator means a larger fraction.”,
    “why_it_occurs”: “Students apply whole-number logic to fractions, assuming that
bigger numbers always mean bigger quantities.”,
    “student_example”: “A student claims that ⅛ is greater than ¼ because 8 is greater
than 4.”,
    “instructional_remedy”: “Use visual fraction models (like fraction strips or circles) to
show that as the denominator increases, the size of each part decreases.”
  },
  {
    “misconception”: “Multiplication always makes numbers bigger.”,
    “why_it_occurs”: “Early multiplication experiences with whole numbers reinforce the
idea that products are always larger than factors.”,
    “student_example”: “A student says that ½ × ½ must be greater than ½.”,
    “instructional_remedy”: “Provide examples multiplying by fractions less than one,
using real-world contexts (like folding paper) to show that the result is smaller.”
  },
  {
    “misconception”: “The equals sign means ‘find the answer.’”,
    “why_it_occurs”: “Students are often exposed to equations only in the form a + b = c,
leading them to see ‘=’ as a prompt for calculation rather than as a symbol of equivalence.”,
    “student_example”: “Given 5 + 3 = _{——} + 2, a student writes 8 in the blank.”,
    “instructional_remedy”: “Use balance scales and equations with unknowns on both
sides to reinforce the concept of equivalence.”
  },
  {
    “misconception”: “You can subtract a smaller number from a larger number but not the
other way around.”,
    “why_it_occurs”: “Students' early experiences with subtraction focus on ‘taking away’
and often avoid negative numbers.”,
    “student_example”: “A student says 3 − 5 is not possible.”,
    “instructional_remedy”: “Introduce number lines and real-world contexts (like owing
money) to demonstrate subtraction resulting in negative numbers.”
  }
```

### Common Misconception Validator:

ROLE
You are an expert educational reviewer.

TASK:
Your task is to validate the following JSON array of misconceptions, which was generated for a specific Common Core substandard.

### Validation Criteria:

The output must be valid JSON and an array with 2-4 objects.
Each object must have all four required fields: “misconception”, “why_it_occurs”, “student_example”, and “instructional_remedy”.
All fields must be non-empty, specific, and written in clear, professional language suitable for assessment developers.
Each misconception must:
   Be tightly aligned to the provided substandard assessment boundary, and grade level.
   Describe a real, research-backed, or commonly observed student error—not a trivial or generic misunderstanding.
   Explain the origin of the misconception in a way that demonstrates understanding of student thinking.
   Provide a realistic student example (actual language, error, or reasoning a student might use).
   Offer an instructional remedy that is actionable, research-informed, and tailored to the misconception.
   Not reference skills, representations, or contexts that are explicitly excluded by the assessment boundary for the substandard.
Reject outputs that have:
   Vague, generic, or repetitive misconceptions.
   Superficial or circular explanations (e.g., “students misunderstand because they don't understand”).
   Weak or impractical remedies.
   Misconceptions that do not fit the concept or grade level, or assessment boundary.
   Any missing, empty, or placeholder fields.
INSTRUCTIONS:
   Carefully review the JSON against all criteria above.
   If the output meets all criteria, respond:
   “VALID: High-quality misconceptions output.”
   If any issue is found, respond:
   “INVALID: [brief explanation of what is missing, incorrect, or low-quality].”
   Provide a numbered list of specific issues if any are found.

### Example of a High-Quality Entry:

```
  {
    “misconception”: “A larger denominator means a larger fraction.”,
    “why_it_occurs”: “Students apply whole-number logic to fractions, assuming that bigger
numbers always mean bigger quantities.”,
    “student_example”: “A student claims that ⅛ is greater than ¼ because 8 is greater
than 4.”,
    “instructional_remedy”: “Use visual fraction models (like fraction strips or circles) to
show that as the denominator increases, the size of each part decreases.”
  }
  Begin validation now.
```

Task Generation Prompt: The Tasks field enumerates representative task archetypes that collectively map the breadth of the concept without restricting to a single scenario. This list functions as a design scaffold to:
(1) Ensure coverage of all essential skills and cognitive processes
(2) Support diverse contexts and representations
(3) Prevent the inadvertent omission of important dimensions of the learning goal

### Exemplary Task Generation Prompt is Given Below—

CONTEXT
You are an expert curriculum designer specializing in elementary education and deeply familiar with Common Core State Standards and assessment design. For the substandard [substandard ID] [substandard description] as defined in Common Core Standard [common core parent standard code], and given the following assessment boundaries: [assessment boundary], enumerate representative task archetypes that collectively map the breadth of the concept, while strictly adhering to the assessment boundary.
TASK
Generate a comprehensive list of task archetypes that:
   Cover all essential skills and cognitive processes required by the substandard.
   Support diverse contexts and representations (e.g., real-world applications, visual models, symbolic tasks).
   Prevent the omission of important dimensions of the learning goal by including tasks that address different modalities, formats, and levels of complexity.
INSTRUCTIONS
   Identify distinct task archetypes that together span the full scope of the concept, without restricting to a single scenario or context, and without redundancy.
   For each archetype:
      Provide a concise, descriptive name.
      Write a brief description of the task type, including the skill(s) or process(es) it targets and the context or representation used.
      Specify the cognitive process or skill focus (e.g., recall, application, analysis, modeling, reasoning).
   Ensure the list includes a range of contexts and representations as permitted by the substandard and assessment boundary (e.g., visual, symbolic, or verbal tasks if allowed). Do not include task types that require contexts, representations, or applications explicitly excluded by the assessment boundary or reserved for other substandards.
   Use clear, actionable language appropriate for assessment developers and curriculum writers.
OUTPUT
Return your answer as a JSON array of objects, using the following schema:

```
text
[
  {
    “archetype_name”: “string (concise name for the task archetype)”,
    “description”: “string (brief description of the task type and context)”,
    “skill_focus”: “string (cognitive process or skill targeted)”
  }
]
```

### EXAMPLES

### Example 1—CCSS.MATH.CONTENT.4.NBT.A.2+1

Convert large numbers between word form, standard form and expanded form.

```
  [
    {
      “archetype_name”: “Convert Standard to Word Form”,
      “description”: “Given a multi-digit number in standard form, write it in word form.”,
      “skill_focus”: “Translation between representations”
    },
    {
      “archetype_name”: “Convert Word to Standard Form”,
      “description”: “Given a number written in words, write the corresponding standard
numeral.”,
      “skill_focus”: “Translation between representations”
    },
    {
      “archetype_name”: “Convert Standard to Expanded Form”,
      “description”: “Given a multi-digit number in standard form, express it in expanded
form (e.g., 4,205 = 4,000 + 200 + 5).”,
      “skill_focus”: “Decomposition and place value understanding”
    },
    {
      “archetype_name”: “Identify Incorrect Representation”,
      “description”: “Given a number and several representations, identify which
representation (word, standard, or expanded) is incorrect.”,
      “skill_focus”: “Error analysis and reasoning”
    },
    {
      “archetype_name”: “Match Representations”,
      “description”: “Given a set of numbers in different forms, match each standard form to
its correct word and expanded forms.”,
      “skill_focus”: “Comparison and matching”
    }
  ]
```

### Example 2—CCSS.MATH.CONTENT.4.OA.C.5+2

Generate a number pattern that follows a given rule, or features that are either explicitly stated or become apparent through observation, considering both types to understand the pattern fully.

```
  [
    {
      “archetype_name”: “Generate Pattern from Rule”,
      “description”: “Given a rule (e.g., add 3 each time), generate the first several terms of
the number pattern.”,
      “skill_focus”: “Pattern generation and rule application”
    },
    {
      “archetype_name”: “Identify Rule from Pattern”,
      “description”: “Given a sequence of numbers, determine the rule that generates the
pattern.”,
      “skill_focus”: “Pattern recognition and reasoning”
    },
    {
      “archetype_name”: “Describe Pattern Features”,
      “description”: “Given a number pattern, describe features such as
increasing/decreasing, constant difference, or other observable properties.”,
      “skill_focus”: “Observation and mathematical description”
    },
    {
      “archetype_name”: “Continue Pattern”,
      “description”: “Given a partial number pattern and its rule, extend the pattern by
several more terms.”,
      “skill_focus”: “Predictive reasoning”
    },
    {
      “archetype_name”: “Error Analysis in Patterns”,
      “description”: “Given a pattern with an error, identify and correct the mistake.”,
      “skill_focus”: “Error analysis”
    }
  ]
```

### Task Validation Prompt:

ROLE
You are an expert educational reviewer.
INPUTS
   tasks_json: The JSON array of task archetypes to validate.
   substandard_id: The official substandard identifier (e.g., “CCSS.MATH.CONTENT.4.NBT.A.2+1”).
   substandard_description: The text description of the substandard.
   assessment_boundary: The official assessment boundary for this substandard, listing what is excluded from assessment.
TASK
   Your task is to validate the provided tasks_json against the substandard, assessment boundary, and best practices for task design.
VALIDATION CRITERIA
   The output must be valid JSON and an array with at least 5 objects.
   Each object must have all three required fields: “archetype_name”, “description”, and “skill_focus”.
   All fields must be non-empty, specific, and written in clear, professional language suitable for assessment developers.
   Each task archetype must:
      Be tightly aligned to the substandard_id and substandard_description.
      Be within the assessment_boundary (not referencing excluded skills, representations, or contexts).
      Clearly describe a distinct, representative task type required by the substandard, not a generic or overlapping scenario.
      Address a specific skill, process, or representation called for by the substandard.
      Avoid overlap with other substandards (do not include task types that belong to a different concept or grade).
   Reject outputs that have:
      Vague, generic, or repetitive task archetypes.
      Tasks that do not fit the concept, grade level, or assessment boundary.
      Any missing, empty, or placeholder fields.
INSTRUCTIONS
Carefully review the tasks_json against all criteria above, the substandard, and the assessment
boundary.
If the output meets all criteria, respond:
“VALID: High-quality task archetypes output.”
If any issue is found, respond:
“INVALID: [brief explanation of what is missing, incorrect, or low-quality].”
Provide a numbered list of specific issues if any are found.

### Example of a High-Quality Entry

```
json
{
  “archetype_name”: “Convert Standard to Word Form”,
  “description”: “Given a multi-digit number in standard form, write it in word form.”,
  “skill_focus”: “Translation between representations”
}
BEGIN VALIDATION NOW.
```

Prerequisite Knowledge Generation Prompt: The Prerequisite Knowledge field lists the discrete, observable skills that students are presumed to have mastered before engaging with the new lesson. By articulating these immediate foundations, the field guides instructional scaffolding, informs placement decisions in adaptive systems, and raises flags to the specific pre-teaching or review that may be necessary to set learners up for success.

### Exemplary Prerequisite Knowledge Generation Prompt is Given Below—

ROLE
You are an expert elementary math curriculum designer.
TASK
Your task is to identify the most essential prerequisite skills and concepts that a student should have mastered prior to learning a specific [grade]-grade substandard.
INPUTS
   Substandard: [Substandard ID] [Substandard Description]
   Assessment Boundary: [Assessment Boundary]
   Tasks: [Tasks]
INSTRUCTIONS
   Carefully review the Substandard, Assessment Boundary, and Tasks.
   Infer and list the prerequisite skills or concepts that are essential for success with this substandard.
   Prerequisites should be:
      Observable and assessable (not vague dispositions).
      Strictly aligned with the scope and representations permitted by the Assessment Boundary.
      Directly relevant to the specific mathematical actions and representations required by the substandard (e.g., if the substandard is about multi-digit multiplication, include single-digit multiplication as a prerequisite).
   Do not include skills or knowledge that are outside the permitted scope or explicitly excluded by the Assessment Boundary.
   Use clear, concise, learner-friendly language.
   Return your answer as a bulleted list (no numbering, no extra commentary).
   OUTPUT EXAMPLE
   CCSS.MATH.CONTENT.4.NBT.A.2+1 Convert large numbers between word form, standard form and expanded form.

### Prerequisite Knowledge

Recognize and write numbers up to 1,000 in standard and word form.
Understand the value of each digit in a three-digit number (place value).
Compose and decompose numbers using hundreds, tens, and ones.
Read and interpret numbers written in expanded form up to 1,000.
Match numbers in different representations (standard, word, expanded) for numbers less than 1,000.

### Prerequisite Knowledge Validator Prompt:

ROLE
You are an expert educational reviewer.
INPUTS
Prerequisites List: The bulleted list of prerequisite skills or concepts to validate.
Substandard ID: The official substandard identifier (e.g., “CCSS.MATH.CONTENT.4.NBT.A.2+1”).
Substandard Description: The text description of the substandard.
Assessment Boundary: The official assessment boundary for this substandard.
Tasks: The list of task archetypes for the substandard.

### Task

Validate the provided Prerequisites List against the substandard, assessment boundary, and best practices for prerequisite knowledge.

### Validation Criteria

The output must be a bulleted list.
Each item must be an observable, assessable skill or concept (not a vague disposition or attitude).
All prerequisites must:
   Be tightly aligned to the Substandard ID, Substandard Description, and the specific skills, representations, and contexts required by the tasks.
   Be within the Assessment Boundary (not referencing excluded skills, representations, or contexts).
   Be grade-appropriate.
   Be specific to the mathematical actions or representations required by the substandard.
Reject outputs that have:
   Vague, generic, or repetitive prerequisites.
   Prerequisites not relevant to the substandard, assessment boundary, or tasks.
   Any missing, empty, or placeholder items.

### Instructions

Carefully review the Prerequisites List against all criteria above, the substandard, and the assessment boundary.

If the output meets all criteria, respond:
“VALID: High-quality prerequisite knowledge list.”
If any issue is found, respond:
“INVALID: [brief explanation of what is missing, incorrect, or low-quality].”
Provide a numbered list of specific issues if any are found.

### Example of a High-Quality Entry

For substandard “Convert large numbers between word form, standard form and expanded form” (CCSS.MATH.CONTENT.4.NBT.A.2+1):
Recognize and write numbers up to 1,000 in standard and word form.
Understand the value of each digit in a three-digit number (place value).
Compose and decompose numbers using hundreds, tens, and ones.
Read and interpret numbers written in expanded form up to 1,000.
Match numbers in different representations (standard, word, expanded) for numbers less than 1,000.
BEGIN VALIDATION NOW.

Difficulty Matrix Generator Prompt: The Difficulty Levels field defines a three-tier taxonomy—Easy, Medium, Hard—that distinguishes items by both qualitative traits (number of solution steps, presence of extraneous information, degree of abstraction) and quantitative limits (number ranges, lexical complexity, unfamiliar contexts). Establishing these anchors gives item writing a shared yardstick for calibrating new questions, enables psychometric balance, and fuels adaptive algorithms that need clearly delineated difficulty bands to personalize practice.

### Exemplary Difficulty Matrix Generator Prompt is Given Below—

ROLE
You are an expert assessment designer specializing in elementary mathematics.
TASK
Your task is to define clear, actionable criteria for Easy, Medium, and Hard items for a specific grade—[Grade] substandard.
INPUTS
   Substandard: [Substandard ID] [Substandard Description]
   Assessment Boundary: [Assessment Boundary]
   Tasks: [Tasks]
   Prerequisite Knowledge: [Prerequisite Knowledge]
INSTRUCTIONS
   Carefully review the Substandard, Assessment Boundary, Tasks, and Prerequisite Knowledge.
   Define three distinct difficulty levels: Easy, Medium, and Hard for assessment items aligned to this substandard, as they would be used in standardized test design.
   For each level, describe:
      Qualitative traits: e.g., number of solution steps, familiarity of context, degree of abstraction, required representations, and cognitive demand.
      Quantitative limits: e.g., number ranges, number of operations, lexical complexity, and expected percent of students who would answer correctly (if applicable).
   Use language and criteria consistent with standardized test development:
      Easy: Items most students with prerequisite knowledge can answer correctly (typically 85%+correct response rate); single-step, familiar context, minimal reading.
      Medium: Items requiring moderate reasoning or multiple steps, some distractors, or less familiar contexts (typically 51-84% correct response rate); may require integrating two skills or representations.
      Hard: Items that challenge even well-prepared students (typically ≤50% correct response rate); multi-step, abstract, or unfamiliar context.
   Anchor all criteria in the actual scope of the substandard, respecting the Assessment Boundary and Tasks.
   Do not include any extraneous or irrelevant information at any difficulty level. All information in each item must be necessary and directly related to the mathematical skill or concept being assessed.
   Return your answer as a JSON object with three fields: “Easy”, “Medium”, and “Hard”. Each field should contain a bulleted list of criteria.
OUTPUT EXAMPLE
Inputs:
   Substandard: Convert large numbers between word form, standard form, and expanded form (CCSS.MATH.CONTENT.4.NBT.A.2+1)
   Assessment Boundary: Numbers≤1,000,000; only whole numbers; no decimals, fractions, or non-standard representations.
Tasks: (examples)
   Convert standard to word form
   Convert word to expanded form
   Compare multi-digit numbers using >, =, <
   Error analysis in number forms
Prerequisite Knowledge:
   Read/write numbers up to 1,000 in standard and word form
   Understand place value for 3-digit numbers
   Compose/decompose numbers using hundreds, tens, and ones

### Output:

```
  {
    “Easy”: [
      “Single-step conversion between two forms (e.g., standard → word) for numbers up to
10,000.”,
      “No extraneous information; every detail is necessary for the task.”,
      “Numbers with zeros only in the ones or tens place (e.g., 3,405).”,
      “Simple, familiar contexts; minimal reading required.”,
      “Direct prompts with clear instructions.”
    ],
    “Medium”: [
      “Two-step tasks (e.g., standard → expanded → word) for numbers up to 100,000.”,
      “All information provided is required to solve the problem; no irrelevant details.”,
      “Numbers may have zeros in multiple places (e.g., 40,506).”,
      “Contexts may be less familiar but remain relevant and concise.”,
      “Moderate reading demand; precise mathematical language.”
    ],
    “Hard”: [
      “Multi-step problems requiring comparison or error analysis across three
representations.”,
      “All information is relevant and essential to the mathematical reasoning required by
the substandard.”,
      “Numbers up to 1,000,000, including those with zeros in non-terminal positions (e.g.,
1,020,305).”,
      “Tasks may require justifying conversions using place value principles or interpreting
more abstract prompts.”,
      “Higher reading demand; numbers may be close in value, increasing cognitive load.”
    ]
  }
```

### Difficulty Matrix Validator Prompt:

ROLE
You are an expert educational reviewer for standardized math assessments.

### Inputs

Difficulty Levels: The “Easy”, “Medium”, and “Hard” fields to validate.
Substandard ID: The official substandard identifier (e.g., “CCSS.MATH.CONTENT.4.NBT.A.2+1”).
Substandard Description: The text description of the substandard.
Assessment Boundary: The official assessment boundary for this substandard.
Tasks: The task archetypes for this substandard.
Prerequisite Knowledge: The bulleted list of prerequisite skills or concepts.

### Task

Validate the provided Difficulty Levels against the substandard, assessment boundary, tasks, and prerequisite knowledge.

### Validation Criteria

The output must be a JSON object with exactly three fields: “Easy”, “Medium”, and “Hard”.
Each field must contain a bulleted list of 3-6 clear, actionable criteria.
All criteria must:
   Be tightly aligned to the Substandard ID, Substandard Description, Tasks, and Prerequisite Knowledge.
   Respect the Assessment Boundary (no numbers, skills, or representations outside the allowed scope).
   Clearly distinguish between Easy, Medium, and Hard using both qualitative (steps, abstraction, context, cognitive demand) and quantitative (number ranges, operations, reading demand) traits.
   Never include extraneous or irrelevant information at any level. All details must be necessary and directly related to the mathematical skill or concept being assessed.
Reject outputs that have:
   Vague, generic, repetitive, or overlapping criteria.
   Criteria not relevant to the substandard, assessment boundary, tasks, or prerequisite knowledge.
   Any missing, empty, or placeholder fields.
   Any mention of including extraneous information or irrelevant details at any level.

### Instructions

Carefully review the Difficulty Levels against all criteria above, the substandard, assessment boundary, tasks_json, and prerequisite knowledge.
If the output meets all criteria, respond:
“VALID: High-quality difficulty levels output.”
If any issue is found, respond:
“INVALID: [brief explanation of what is missing, incorrect, or low-quality].”
Provide a numbered list of specific issues if any are found.

### Example of a High-Quality Entry

```
  {
    “Easy”: [
      “Single-step conversion between two forms (e.g., standard → word) for numbers up to
10,000.”,
      “No extraneous information; every detail is necessary for the task.”,
      “Numbers with zeros only in the ones or tens place (e.g., 3,405).”,
      “Simple, familiar contexts; minimal reading required.”,
      “Direct prompts with clear instructions.”
    ],
    “Medium”: [
      “Two-step tasks (e.g., standard → expanded → word) for numbers up to 100,000.”,
      “All information provided is required to solve the problem; no irrelevant details.”,
      “Numbers may have zeros in multiple places (e.g., 40,506).”,
      “Contexts may be less familiar but remain relevant and concise.”,
      “Moderate reading demand; precise mathematical language.”
    ],
    “Hard”: [
      “Multi-step problems requiring comparison or error analysis across three
representations.”,
      “All information is relevant and essential to the mathematical reasoning required by
the substandard.”,
      “Numbers up to 1,000,000, including those with zeros in non-terminal positions (e.g.,
1,020,305).”,
      “Tasks may require justifying conversions using place value principles or interpreting
more abstract prompts.”,
      “Higher reading demand; numbers may be close in value, increasing cognitive load.”
    ]
  }
  BEGIN VALIDATION NOW.
```

Direct Instruction Generation Prompt: The Direct Instruction field presents a structured teaching blueprint that through research, has proved effective for moving learners from initial exposure of a concept, to independent mastery. It records the recommended sequence of sub-skills or representations (for example, concrete→pictorial→abstract), highlights effective teaching strategies, and marks transition points from guided to independent practice. By encapsulating these research-backed steps, the field's purpose is to provide curriculum development with an immediately actionable roadmap that reliably produces conceptual understanding and procedural fluency.

### Exemplary Direct Instruction Generation Prompt is Given Below—

ROLE
You are an expert elementary math curriculum designer specializing in Direct Instruction (DI).

### Task

Your task is to create a concise, self-contained, step-by-step instructional sequence for a specific grade [grade] substandard, formatted for a self-paced app.

### Inputs

Substandard: [{Substandard ID] [Substandard Description]
Assessment Boundary: [Assessment Boundary]
Tasks: [Tasks]
Common Misconceptions:
   Misconception 1: [Common Misconception 1]
   Misconception 2: [Common Misconception 2]
   Misconception 3: [Common Misconception 3]
   Misconception 4: [Common Misconception 4]
Prerequisite Knowledge: [Prerequisite Knowledge]
Difficulty Levels: [Difficulty Levels]

### Instructions

Carefully review all inputs.
Strictly align every instructional step, representation, and example with the Assessment Boundary and Tasks.
Omit or adapt any instructional step, representation, or term that is excluded by the Assessment Boundary or not present in Tasks.
If a typical DI sequence (e.g., Concrete→Pictorial→Abstract) is not fully supported, adapt accordingly and briefly note the adaptation.
Do not reference representations, contexts, or approaches not permitted by these inputs.
If a section is not applicable due to input constraints, omit it or state that it is not applicable.
Do not repeat or restate input lists verbatim; synthesize and tailor content to the substandard and boundaries.
Use explicit, systematic, and stepwise language, modeling the approach after well-researched DI programs.
Write for a solo learner (no classroom/teacher language).

### Output

##Direct Instruction Sequence for “[Substandard Description]” ([Substandard ID])
*One-sentence focus statement distilled from the substandard.*
###Prerequisite Knowledge
   Essential prior skills/concepts.
###Mathematically Precise Vocabulary
   Terms with ≤10-word, learner-friendly definitions (aligned with substandard and tasks).
###Direct Instruction Sequence
1. **Advance Organizer**: Briefly state the lesson's goal and its real-world relevance (if allowed).
2. **Assess Background Knowledge**: Quick self-check or review of prerequisites.
3. **Explicit Modeling**: Step-by-step demonstration of the skill, using only representations and contexts permitted by the Assessment Boundary and Tasks.
4. **Guided Practice**: Scaffolded, sequenced problems increasing in complexity per difficulty level; provide immediate feedback or self-checks.
5. **Independent Practice**: Practice problems mirroring the full range of tasks and difficulty matrix, with instant self-assessment.
6. **Error Correction & Feedback**: Pre-empt common misconceptions with targeted tips or clarifications.
###Scaffolding & Progression
   Sequence representations (concrete, pictorial, symbolic) only if allowed by the Assessment Boundary and Tasks.
   Progress from simple to complex per difficulty levels.
   Adapt or omit steps if certain representations/contexts are excluded; briefly note any adaptation.
###Mathematical Reasoning (The Why)
   Concise bullets explaining the logic or principles behind the concept, tailored to the substandard and tasks.
###Efficiency Strategy (After Mastery)
   One mnemonic/shortcut plus the math justification (only if not excluded by Assessment Boundary).
###Problem Types to Include
   ≥5 generic formats, strictly aligned with the tasks (avoid naming item types).
###Self-Check Prompts
   3-5 instant self-reflection questions for learners to verify understanding.
###Common Misconceptions to Pre-empt
   List the four common misconceptions, each with a preventive tip (pad with blanks if fewer than four).

### Direct Instruction Validator Prompt:

ROLE
You are an expert educational reviewer specializing in math curriculum and explicit instruction design.

### Inputs

DI Output: [Direct Instruction Sequence (markdown)]
Substandard: [Substandard ID] [Substandard Description]
Assessment Boundary: [Assessment Boundary]
Tasks: [Tasks]
Misconceptions: [Common Misconception 1-4]
Prerequisites: [Prerequisite Knowledge]
Difficulty Levels: [Difficulty Levels]

### Task

Validate the DI Output against all input constraints and instructional design best practices.

### Validation Criteria

### Structural Integrity

### Contains all Required Sections in Order:

1. Focus Statement
2. Prerequisite Knowledge
3. Vocabulary
4. Direct Instruction Sequence
5. Scaffolding & Progression
6. Mathematical Reasoning
7. Efficiency Strategy
8. Problem Types
9. Self-Check Prompts
10. Misconceptions
   No markdown syntax errors
   No classroom/teacher language

### Content Alignment

Focus statement precisely reflects substandard's core intent
Prerequisite Knowledge:
   All inferrable from grade-level progression
   Vocabulary:
      5-10 terms directly tied to substandard
      Definitions ≤10 words, learner-friendly
   Instruction Sequence:
      All examples/representations permitted by assessment boundary
      No excluded contexts or representations
      Guided/Independent practice matches difficulty_levels progression
   Scaffolding:
      CPA sequence only if allowed by tasks/assessment boundary
      Explicitly notes any adaptations to standard progression
   Problem Types
      Generic but traceable to tasks
      No mention of specific item types (MCQ, etc.)
   Misconceptions:
      All 4 addressed (blanks allowed if <4 provided)
      Preventive tips directly counter misconception mechanisms

### Style Compliance

Bullet lists everywhere except focus statement
No cross-grade comparisons
No curriculum/product references
“Quick Trick” mathematically justified if present
Self-checks are open-ended reflection prompts

### Instructions

1. Analyze DI Output section-by-section against criteria
2. Verify against all inputs (substandard, boundary, tasks, etc.)
3. If fully compliant:
   Respond with “VALID: Direct Instruction sequence meets all requirements.”
4. If any issues:
   Respond with “INVALID: [concise problem summary]”
      Numbered list of specific violations with line references

### Examples

### Valid Output

CCSS.MATH.CONTENT.4.NBT.A.2+1
Convert large numbers between word form, standard form, and expanded form.
##Direct Instruction Sequence for “Convert large numbers between word form, standard form, and expanded form” (CCSS.MATH.CONTENT.4.NBT.A.2+1)
*Learn to accurately convert multi-digit numbers among standard, word, and expanded forms.*
###Prerequisite Knowledge
   Recognize and write numbers up to 1,000 in standard and word form.
   Understand place value for three-digit numbers.
   Compose and decompose numbers using hundreds, tens, and ones.
   Read and interpret numbers in expanded form up to 1,000.
###Mathematically Precise Vocabulary
   Standard form: Number written using digits (e.g., 4,205).
   Word form: Number written in words (e.g., four thousand two hundred five).
   Expanded form: Number written as a sum showing place value (e.g., 4,000+200+5).
   Digit: Any single number from 0 to 9.
   Place value: Value of a digit based on its position.
   Sum: The result of addition.
   Thousands: The fourth place from the right in a whole number.
   Hundreds: The third place from the right in a whole number.
###Direct Instruction Sequence
1. **Advance Organizer**: Today you'll learn to convert large numbers between different forms, a skill useful for reading data, writing checks, or understanding math problems.
2. **Assess Background Knowledge**: Can you write 356 in words? What does the digit 5 represent in 356?
3. **Explicit Modeling**: Watch as 4,205 is shown in standard form, then written as “four thousand two hundred five” (word form), and then as 4,000+200+5 (expanded form). Notice how each digit's place value matches its part in expanded form.
4. **Guided Practice**: Convert 7,018 between all three forms with hints. Try 82,060 with step-by-step feedback.
5. **Independent Practice**: Convert 56,430 to word and expanded form. Given “ninety thousand, three hundred twelve,” write standard and expanded forms. Self-check answers instantly.
6. **Error Correction & Feedback**: If you write “four thousand twenty five” for 4,205, check if you missed a place value. If expanded form doesn't match the digits, review each digit's value.
###Scaffolding & Progression
   Begin with concrete examples using place value blocks (if allowed), then move to pictorial representations, and finally to abstract conversions.
   Problems progress from numbers with no zeros to numbers with zeros in various places.
   If concrete modeling is not allowed, start with pictorial or direct symbolic conversion.
###Mathematical Reasoning (The Why)
   Place value explains why each digit's position matters.
   Expanded form shows how numbers are built from sums of each place value.
   Word form connects math to everyday language.
   Accurate conversion helps avoid errors in reading or writing numbers.
###Efficiency Strategy (After Mastery)
   “Say and Split”: Say the number aloud, then split it into place values for expanded form.
   Justification: Saying and splitting reduces mistakes by focusing on each digit's value.
###Problem Types to Include
   Convert standard to word form.
   Convert word to expanded form.
   Convert expanded to standard form.
   Match numbers in different forms.
   Identify and correct mistakes in conversions.
###Self-Check Prompts
   Did I use the correct place value for each digit?
   Does my expanded form add up to the original number?
   Does my word form match the digits in standard form?
   Did I check for missing or extra zeros?
###Common Misconceptions to Pre-empt
   Confusing digit position and value-always check place value.
   Skipping or misreading zeros-verify each place.
   Mixing up word and expanded forms-double-check each step.
BEGIN VALIDATION NOW.

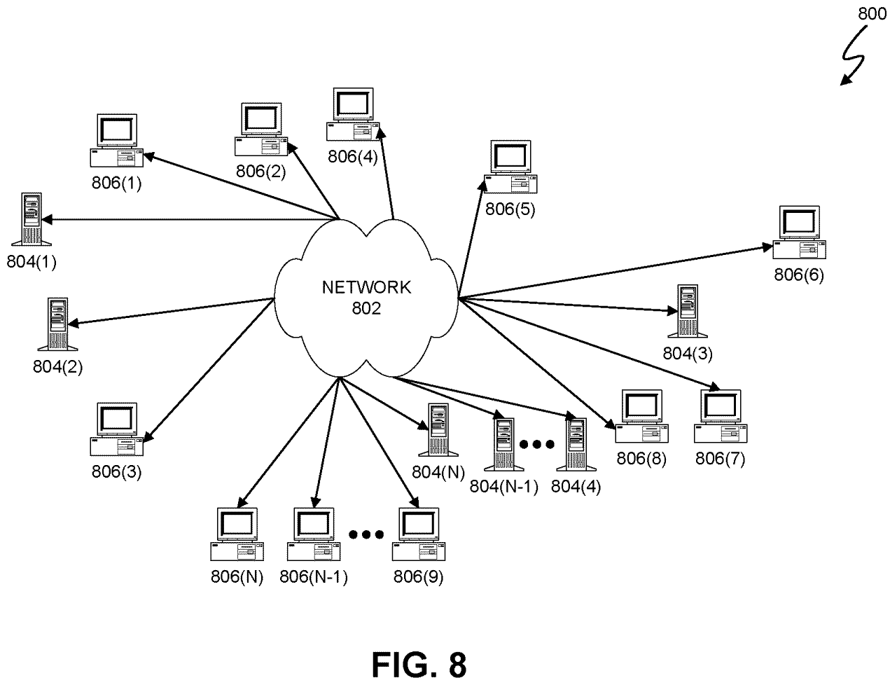

FIG. 8 is a block diagram illustrating a network environment in which a content generation system 100 and content generation process 200 may be practiced. Network 802 (e.g. a private wide area network (WAN) or the Internet) includes a number of networked server computer systems 804(1)-(N) that are accessible by client computer systems 806(1)-(N), where N is the number of server computer systems connected to the network. Communication between client computer systems 806(1)-(N) and server computer systems 804(1)-(N) typically occurs over a network, such as a public switched telephone network over asynchronous digital subscriber line (ADSL) telephone lines or high-bandwidth trunks, for example communications channels providing T1 or OC3 service. Client computer systems 806(1)-(N) typically access server computer systems 804(1)-(N) through a service provider, such as an internet service provider (“ISP”) by executing application specific software, commonly referred to as a browser, on one of client computer systems 806(1)-(N).

Client computer systems 806(1)-(N) and/or server computer systems 804(1)-(N) are specialized computer programmed to improve conventional computer systems to implement and utilize the content generation system 100 and content generation process 200. The type of computer system that can be specially programmed to implement and utilize the content generation system 100 and content generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the content generation system 100 and content generation process 200 can be implemented using code stored in a tangible, non-transient computer readable medium and executed by one or more processors. In at least one embodiment, the content generation system 100 and content generation process 200 can be implemented completely in hardware using, for example, logic circuits and other circuits including field programmable gate arrays.

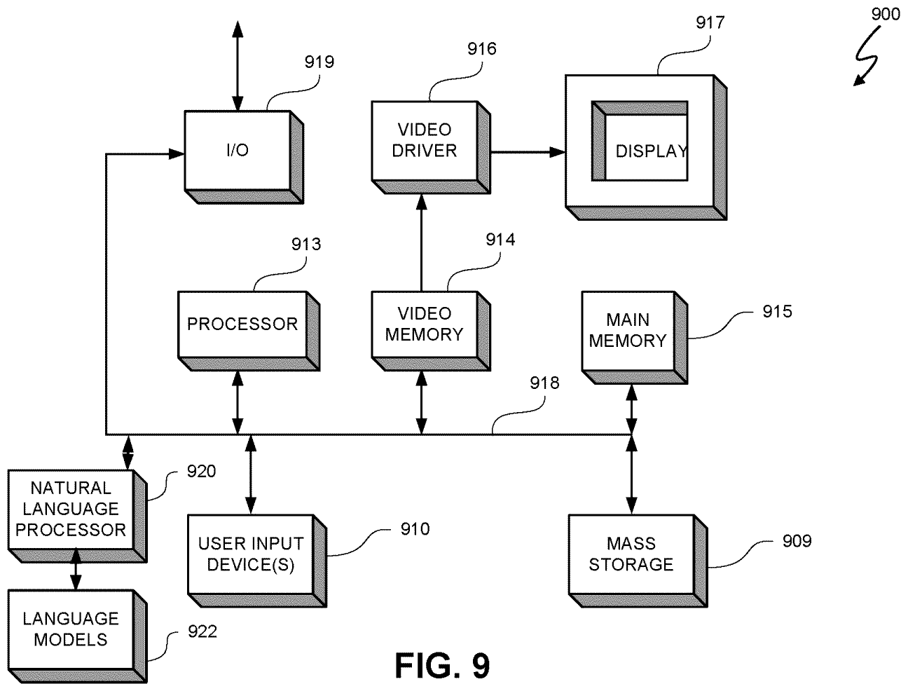

Embodiments of the content generation system 100 and content generation process 200 can be implemented on a computer system such as a special-purpose, special-programmed computer 900 illustrated in FIG. 9. Input user device(s) 910, such as a keyboard and/or mouse, are coupled to a bi-directional system bus 918. The input user device(s) 910 are for introducing user input to the computer system and communicating that user input to processor 913. The computer system of FIG. 9 generally also includes a non-transitory video memory 914, non-transitory main memory 915, and non-transitory mass storage 909, all coupled to bi-directional system bus 918 along with input user device(s) 910 and processor 913. The mass storage 909 may include both fixed and removable media, such as a hard drive, one or more CDs or DVDs, solid state memory including flash memory, and other available mass storage technology. Bus 918 may contain, for example, 32 of 64 address lines for addressing video memory 914 or main memory 915. The system bus 918 also includes, for example, an n-bit data bus for transferring DATA between and among the components, such as CPU 909, main memory 915, video memory 914 and mass storage 909, where “n” is, for example, 32 or 64. Alternatively, multiplex data/address lines may be used instead of separate data and address lines.

I/O device(s) 919 may provide connections to peripheral devices, such as a printer, and may also provide a direct connection to a remote server computer systems via a telephone link or to the Internet via an ISP. I/O device(s) 919 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 909, into main memory 915 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 913, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 915 is comprised of dynamic random access memory (DRAM). Video memory 914 is a dual-ported video random access memory. One port of the video memory 914 is coupled to video amplifier 916. The video amplifier 916 is used to drive the display 917. Video amplifier 916 is well known in the art and may be implemented by any suitable means. This circuitry converts pixel DATA stored in video memory 914 to a raster signal suitable for use by display 917. Display 917 is a type of monitor suitable for displaying graphic images.

The computer system described above is for purposes of example only. The content generation system 100 and content generation process 200 may be implemented in any type of computer system or programming or processing environment. It is contemplated that the content generation system 100 and content generation process 200 might be run on a stand-alone computer system, such as the one described above. The content generation system 100 and content generation process 200 might also be run from a server computer systems system that can be accessed by a plurality of client computer systems interconnected over an intranet network. Finally, the content generation system 100 and content generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding and constraining an Artificial Intelligence (AI) engine for generating educational content by enriching educational standards with additional contextual information, comprising:
executing code using one or more processors of a computer system to cause the computer system to perform operations comprising:
accessing a curriculum database including curriculum guidelines for educational standards;
defining a plurality of extended attribute types, wherein each extended attribute type represents a specific category of additional information relevant to the educational standards;
associating extended attribute type from the plurality of extended attribute types with extended attributes providing detailed information of the extended attribute type;
linking the extended attributes to specific courses of the educational standards, ensuring that the educational content generated is contextualized to the curriculum guidelines for the educational standards;
generating a prompt for guiding and constraining the AI engine to guide a Large Language Model (LLM) to map the extended attributes to specific educational standards, ensuring the contextual enrichment is aligned with the educational standards; and
transferring the prompt to the AI engine to recognize the plurality of extended attribute types and map the plurality of extended attribute types to the educational standards.

2. The method of claim 1 wherein using mapping tables that relate educational standards and courses to extended attributes, facilitating the alignment of educational content generation with the educational standards and contextualization the educational content to the respective courses.

3. The method of claim 1 further comprising:
identifying the learning style and performance data of the user;
selecting extended attributes based on the identified learning style and performance data; and
generating educational content incorporating the selected extended attributes, thereby customizing the educational content.

4. The method of claim 1 wherein each extended attribute is a specific instance that carries a value and belong to a category within extended attribute type for facilitating the structured enrichment of educational standards with additional information.

5. The method of claim 1 wherein generating enriched educational content comprising:
utilizing diverse elements such as historical figures, key terms, and multimedia resources into educational content;
generating the educational content that is both informative and captivating by integrating the diverse elements, thereby enhancing user engagement.

6. The method of claim 1 further comprising:
storing performance data of the user, generated educational content in a database.

7. The method of claim 1 wherein training the AI engine on a dataset comprising educational standards, extended attributes, and performance data of the user, wherein training involves utilizing supervised learning algorithms that predict the effective content types for the user based on the dataset.

8. The method of claim 1 wherein the curriculum database includes curriculum data aligned to one or more educational standards including Common Core State Standards (CCSS), Next Generation Science Standards (NGSS), and Advanced Placement (AP).

9. A system for guiding and constraining an Artificial Intelligence (AI) engine for generating educational content by enriching educational standards with additional contextual information, comprising:
one or more processors;
memory, operatively coupled to the one or more processors that when executed cause the one or more processors to perform operations comprising:
executing code using one or more processors of a computer system to cause the computer system to perform operations comprising:
accessing a curriculum database including curriculum guidelines for educational standards;
defining a plurality of extended attribute types, wherein each extended attribute type represents a specific category of additional information relevant to the educational standards;
associating extended attribute type from the plurality of extended attribute types with extended attributes providing detailed information of the extended attribute type;
linking the extended attributes to specific courses of the educational standards, ensuring that the educational content generated is contextualized to the curriculum guidelines for the educational standards;
generating a prompt for guiding and constraining the AI engine to guide a Large Language Model (LLM) to map the extended attributes to specific educational standards, ensuring the contextual enrichment is aligned with the educational standards; and
transferring the prompt to the AI engine to recognize the plurality of extended attribute types and map the plurality of extended attribute types to the educational standards.

10. The system of claim 9 wherein using mapping tables that relate educational standards and courses to extended attributes, facilitating the alignment of educational content generation with the educational standards and contextualization the educational content to the respective courses.

11. The system of claim 9 further comprising:
identifying the learning style and performance data of the user;
selecting extended attributes based on the identified learning style and performance data; and
generating educational content incorporating the selected extended attributes, thereby customizing the educational content.

12. The system of claim 9 wherein each extended attribute is a specific instance that carries a value and belong to a category within extended attribute type for facilitating the structured enrichment of educational standards with additional information.

13. The system of claim 9 wherein generating enriched educational content comprising:
utilizing diverse elements such as historical figures, key terms, and multimedia resources into educational content;
generating the educational content that is both informative and captivating by integrating the diverse elements, thereby enhancing user engagement.

14. The system of claim 9 further comprising:
a database for storing performance data of the user, generated educational content.

15. The system of claim 9 wherein the AI engine is trained on a dataset comprising educational standards, extended attributes, and performance data of the user, wherein training involves utilizing supervised learning algorithms that predict the effective content types for the user based on the dataset.

16. The system of claim 9 wherein the curriculum database includes curriculum data aligned to one or more educational standards including Common Core State Standards (CCSS), Next Generation Science Standards (NGSS), and Advanced Placement (AP).
